(19) United States
(12) Patent Application Publication
(10) Pub. No.: US 2009/0283971 A1
(43) Pub. Date: Nov. 19, 2009

(54) Method and System for Integrating a Lottery Game with a Deck of Cards

(75) Inventor: Jeffrey D. Martineck, SR., Alpharetta, GA (US)

Correspondence Address: DORITY & MANNING, P.A., POST OFFICE BOX 1449, GREENVILLE, SC, 29602-1449, US

(73) Assignee: SCIENTIFIC GAMES INTERNATIONAL, INC., NEWARK, DE (US)

(21) Appl. No.: 12/426,975

(22) Filed: Apr. 21, 2009

Related U.S. Application Data
(60) Provisional application No. 61/047,775, filed on Apr. 25, 2008.

(51) Int. Cl. A63F 1/02; B42D 15/00

(52) U.S. Cl. 273/293; 283/100

(57) ABSTRACT

A system and methodology for combining a lottery game with playing cards provides a plurality of decks of playing cards to purchasers. Each deck includes a set of a defined number and type of cards to play any manner of card game separate from the lottery game. At least one of the cards within each deck includes a lottery game play area that provides the purchaser of the deck with a chance to win a prize in a first lottery game.

### PRIORITY CLAIM

The present application claims priority to U.S. Provisional Application Ser. No. 61/047,775, filed Apr. 25, 2008.

### FIELD OF THE INVENTION

The present invention relates to the field of lottery games in general, and more particularly to a method and system for integrating a lottery game with a deck or set of cards used to play any manner of conventional card game.

### BACKGROUND

The lottery industry is continuously seeking ways to generate interest and excitement in the gaming experience, and to drawn in new players. For example, certain lottery games offer a bonus play, increased prize multipliers, and other incentives to increase enthusiasm and participation in the game. These concepts, however, all generally involve an extension or continued play of the initial lottery game. Once the lottery game, including the bonus continuations or other game components are completed, the gaming experience is over and the lottery tickets or cards are discarded.

The present invention involves a novel approach to a lottery game method and system wherein the lottery game may be presented or considered by players as a “bonus” feature of a non-lottery game or event that does not end with the lottery game. This unique gaming method and system will appeal to a much larger potential player base, and may result in an entirely new class of players being introduced to the excitement of lottery games.

### SUMMARY

Objects and advantages of the invention will be set forth in part in the following description, or may be obvious from the description, or may be learned through practice of the invention.

In accordance with certain embodiments, a system for combining a lottery game with any type or configuration of playing cards is provided. The system includes a plurality of complete decks of playing cards of any type, wherein each deck has a set of a defined number and type of cards to play a given card game. For example, a typical deck may be, for example a conventional 52-card playing deck used to play any manner of known card game, such as poker, gin rummy, bridge, and so forth. It should be appreciated that the present invention is not limited by the type of cards or card games, and encompasses any deck of cards generally supplied as a set of a defined number and type of cards for playing one or a number of different types of card games.

At least one, and desirably a plurality, of the cards within the deck includes a lottery game play area defined thereon, for example on the playing face, that presents a lottery game theme and provides a purchaser of the deck with a chance to play and win a prize in a first lottery game. In this regard, the card with the lottery game component may also be considered as a unique lottery ticket or card. Desirably, the lottery game play area is only visible from the playing face of the card and, in certain embodiments, all of the cards within the deck have the same visual appearance on the back face such that the cards are indistinguishable when viewed from the back face, as with a conventional deck of poker playing cards.

The decks are offered at various points of sale or distribution, which may include any retail or business establishment that offers other lottery games. The point of sale may be any establishment where a consumer would expect to be able to purchase a deck of cards or other card or board gaming paraphernalia. The various points of sale may be in communication with a central lottery authority via any suitable communications network for control, management, inventory, monitoring, and all other functions related to conduct of a wide area lottery game.

The lottery game play area on the cards within the deck may be formatted for play of various types of lottery games. For example, the lottery game component may be an instant scratch-off game, and the lottery game play area may include the areas to be scratched by a player, whereby the player is immediately aware of whether the card has a winning lottery play. In an alternative embodiment, the lottery game component may be a Lotto-type of game and the play area may include randomly generated indicia that a player attempts to match to indicia drawn in a subsequent lottery drawing by a central lottery authority.

In still another embodiment, the lottery game play area may simply designate the card as a lottery card, wherein all the designated cards are then used as the purchaser's hand or entry in the first lottery game. For example, the first lottery game may be a Lotto-type of game, and the purchaser's entry in the game corresponds to the indicia (i.e., numbers, symbols, etc.) on the cards in the deck designated as lottery cards. Thus, in this scenario, the first lottery game is conducted with the subset of cards within the deck having a lottery play area and, thus, no individual card is considered as a unique lottery ticket.

It should be appreciated that the present game system and methodology are not limited by the particular type of lottery game implemented in the lottery game play area.

In a particular embodiment, a plurality of cards within the deck comprise the lottery game play area. In a unique embodiment, every card may include the game play area. The lottery game play area on the playing face of the cards does not obscure the essential indicia on the card. Thus, even if a card is not a winner in the lottery game component, the card may remain in the deck, and the deck can be used by a purchaser in any manner that a comparable deck unrelated to the lottery game would be used.

In particular embodiments, the system may also provide at least one redemption location wherein purchasers may redeem cards from their deck having a winning lottery game play in the first lottery game. For example, a card within the deck may have a winning instant scratch-off game in the game play area, and the purchaser presents the card for receipt of a prize award at the redemption location. This location may be one of the retail establishments that sell the decks of cards, or a central lottery game establishment. It is desirable for the lottery authority to keep the redeemed cards for a number of reasons, and replacement cards may be provided to the purchaser at the redemption location. The replacement cards are substituted for the redeemed cards so that purchasers still have a complete deck for playing a card game with the deck. The replacement cards have the same back face as every other card in the deck, and may or may not have an indication on the playing face that the card is a substitute for a winning lottery card.

As mentioned, the deck of cards may comprise any manner of known set or compilation of cards for playing a game. The deck may be, for example, a 52-card poker or pinochle playing deck, or any type of deck used to play a wagering or competitive game. In alternative embodiments, the deck may be used in a board game. For example, the deck may be a set of Monopoly® cards used in the popular board game of the same name.

In a unique embodiment, the system may include an additional lottery game component wherein cards within the deck having a winning lottery play in the first lottery game are used as player cards in the additional lottery game. For example, the deck may be a 52-card poker playing deck with a plurality (or all) of the cards having the lottery game play area. The additional lottery game may have a poker theme, and any of the cards having a winning lottery play in the first lottery game may be used as the player's hand in the additional lottery poker game. The lottery authority may have an established payout for various poker hands, and the player may use the winning cards to form the best possible poker hand for a prize value.

In still another embodiment, all of the cards within the deck having a lottery play area (winning or loosing) may be used to form the best possible player hand in the additional lottery game. For example, the deck may contain seven cards with a first lottery game play, and all of the cards may be loosing plays. In this embodiment, however, the purchaser may use all seven of the cards to form the best possible five-card poker hand for the additional lottery poker game. In yet another embodiment, all or any combination of the cards having a lottery play area may provide a player's selection in a subsequent Lotto-style on-line lottery game.

It is desirable, and often required by a lottery jurisdiction, that instructions, disclaimers, notices, signature blocks, and the like, are provided on lottery tickets distributed to the public. To satisfy this requirement, separate notice slips having the desired information or other indicia printed thereon may be provided in the deck packaging, with at least one slip provided for each card having a lottery play area. Instructions may be provided to purchasers that winning lottery cards can only be redeemed if accompanied by one of the slips.

It should be appreciated the invention encompasses individual decks of cards as described herein as stand-alone items.

The present invention also includes various embodiments of a methodology for integrating a lottery game with a deck of playing cards, as related to the system described above. In particular, the method includes making available to purchasers a deck of playing cards having a set of a defined number and type of cards to play any manner of card game. At least one of the cards within each deck is provided with a lottery game play area that provides the purchaser with a chance to win a prize in a first lottery game. All of the cards within the deck are provided with the same visually appearing back face such that the cards are indistinguishable from the back face. Any card within the deck having a winning lottery game play in the first lottery game is redeemed by the lottery authority, and the purchasers are provided replacement cards that are substituted for the redeemed cards so that purchasers have a complete deck for playing the card game after redeeming a card having a winning lottery game play.

Aspects of the invention are described in greater detail below by reference to the embodiments illustrated in the figures.

### BRIEF DESCRIPTION OF THE DRAWINGS

FIG. 1 is a graphical depiction of a deck of playing cards that may utilize aspects of the present invention;

FIG. 1B is a graphical depiction of playing cards from a 52-card poker playing deck utilizing aspects of the invention;

FIG. 1C is an illustration of the back face of playing cards in accordance with aspects of the invention;

FIGS. 2A and 2B are graphical illustrations of playing cards incorporating a lottery game play area on the front face thereof;

FIGS. 3A and 3B are graphical illustrations of the front face of playing cards incorporating features related to a lottery game component;

FIG. 4 is a graphical illustration of the front face of a playing card incorporating features of yet another embodiment of a lottery game component;

FIG. 5 is a diagrammatic view of a system in accordance with certain embodiments of the invention;

FIG. 6 is side view of an embodiment of stack of cards in a fan-folded configuration.

### DESCRIPTION

Reference will now be made in detail to examples of the invention, embodiments of which are illustrated in the drawings. Each example is provided by way of explanation, and not as a limitation of the invention. In fact, it will be apparent to those skilled in the art that modifications and variations can be made without departing from the scope or spirit of the disclosure and claims. For instance, features illustrated or described as part of one embodiment may be used on another embodiment to yield a still further embodiment. Thus, it is intended that the present disclosure includes modifications and variations as come within the scope of the appended claims and their equivalents.

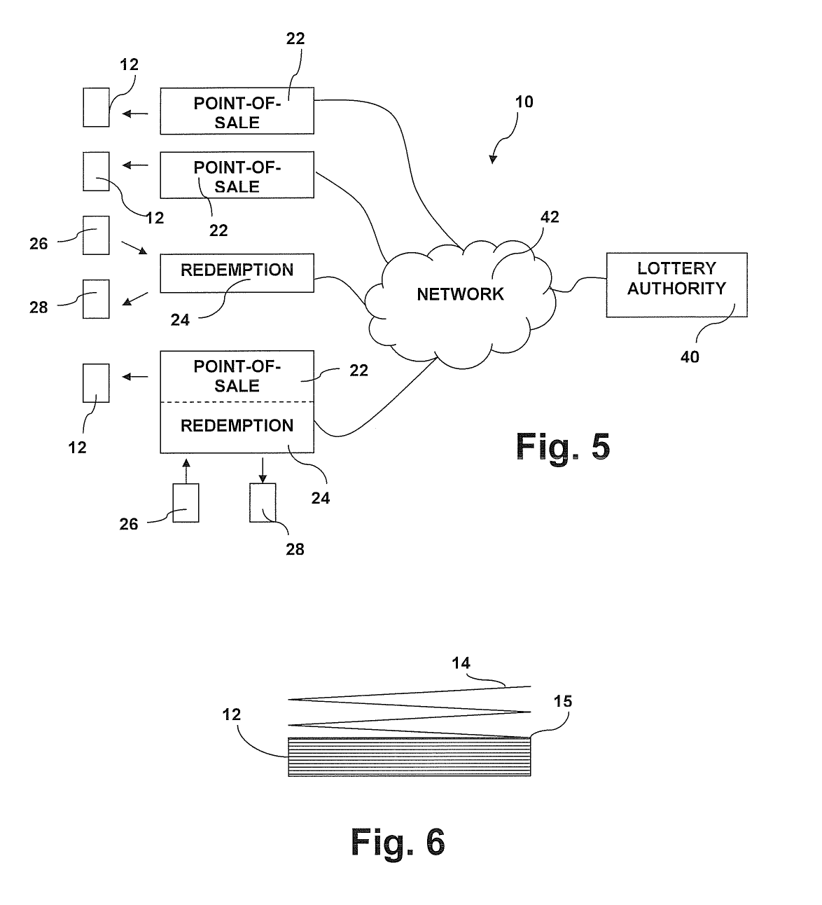

FIG. 5 illustrates concepts of a card system 10 that may be used to practice certain embodiments of the invention. The card system 10 includes multiple decks 12 of playing cards having unique features according to aspects of the invention. The system of FIG. 5 will be discussed in greater detail below.

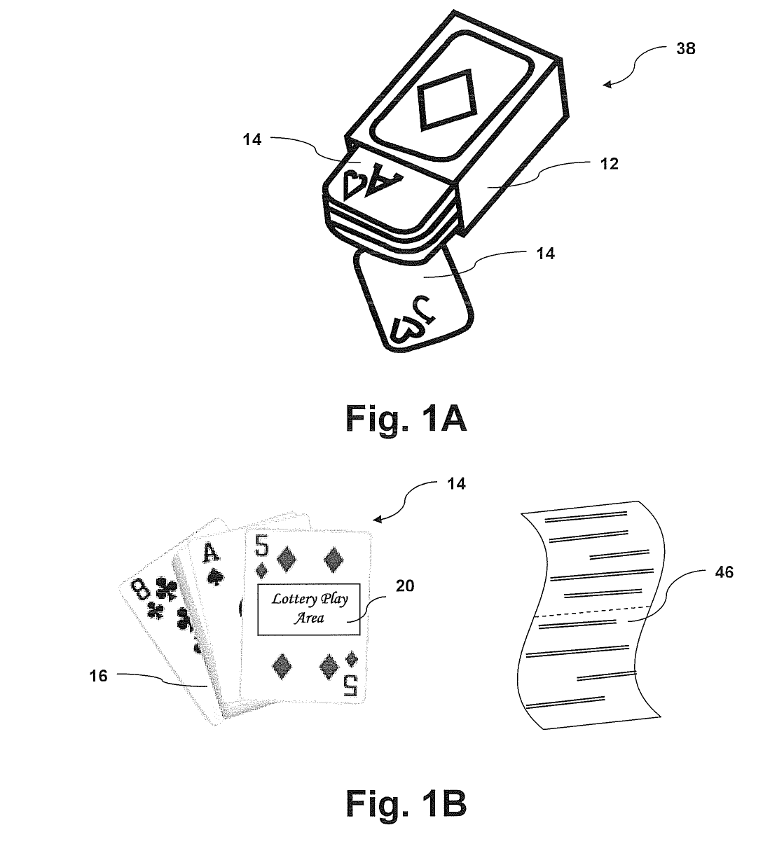

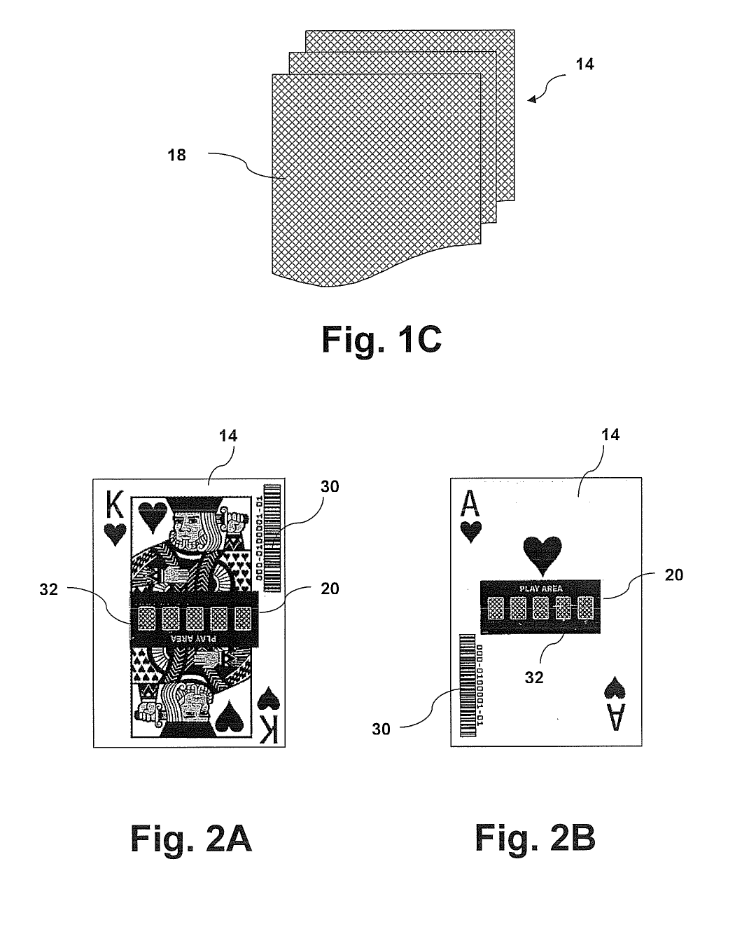

The card deck 12 illustrated in FIG. 1A includes cards 14 corresponding to a standard 52-card poker playing set that is well known and widely used. FIG. 1B illustrates the playing faces of certain of the cards from the deck 12. Although illustrated as conventional playing cards in the figures, it should be appreciated that the invention is not limited by the type of cards or card games that may be played with the cards, and includes any deck 12 of cards generally supplied as a set of a defined number and type of card for playing one or more different types of card games. For example, with the deck 12 of cards 14 illustrated in FIGS. 1A and 1B, a purchaser may play any number of conventional card games, such as poker, bridge, gin, and so forth. In an alternative embodiment, the deck 12 may contain a set of cards 14 that constitute a component of another game, such as a board game. For example, the deck 14 may contain a set of Monopoly® cards for use in a conventional Monopoly® board game, and so forth.

At least one of the cards in the deck 12 includes a lottery game play area 20, as depicted generally in FIG. 1B, and in greater detail in FIGS. 2A and 2B. The lottery game play area 20 provides a purchaser of the deck 12 with the chance to play and win a prize in a first lottery game, as described in greater detail below. Thus, the individual cards within the deck 12 containing the lottery game play area 20 may be thought of as a unique lottery ticket or lottery card within the deck 12. The lottery game play area 20 is only visible from the front or playing face 16 of the cards 14, In certain embodiments, all of the cards within the deck 12 have the same visual appearance on the back face 18 (FIG. C), particularly if the deck 12 is intended to be used as a conventional playing card deck. In this manner, the cards are indistinguishable from the back face, as with any conventional poker playing set. The back face 18 may contain any manner of design, indicia, and the like, as is well known in the art. There may be embodiments, however, wherein it is not necessary for the back faces 18 to have the same appearance, and such embodiments are within the scope and spirit of the invention.

The individual decks 12 may be packaged in accordance with any manner of conventional packaging technique to ensure the integrity of the deck. For example, the decks 12 may come from the manufacturer in a sealed condition, such as with a shrink wrap, sealed plastic case, and the like. As with conventional playing cards, the deck 12 is sold to purchasers with a seal or other means to indicate to the purchaser that the cards are knew and have not been previously opened or used. Although not illustrated in the figures, the case or packaging for the deck 12 may include any manner of indicia indicating that the deck is a unique lottery product, and not a conventional deck of cards. The case may also include any manner of security device, markings, or the like, including a bar code, identification tag, RFID tag, and so forth.

The decks 12 may be initially supplied from the manufacturer with the cards 14 individually separated, but packaged as a complete set in a box, case, or any other suitable package. In an alternate configuration depicted in FIG. 6, the deck 12 contains a stack of fan-folded cards 14 that are connected along separation lines 15 at their respective longitudinal edges, whereby the purchaser may easily separate the cards 14 at the lines 15 at some later time. This configuration may have benefits from a manufacturing standpoint in that integrity and security of the deck can be closely controlled, and the prevention of certain types of fraud may be easier.

Referring to FIG. 1B, notice slips 46 may be separately provided as a component of the deck 12. For example, the slips 46 may be provided in the box or packaging associated with the deck 12. As mentioned, the slips 46 may contain any manner of instructions, disclaimers, notices, signature blocks, and the like, that are required by a lottery jurisdiction, or otherwise desired to be provided with lottery cards in general. To ensure a player's compliance with the lottery game regulations, instructions may be provided to purchasers that winning lottery cards can only be redeemed if accompanied by one of the slips.

Referring to FIG. 5, the system 10 for combining a lottery game with the playing cards is illustrated. As mentioned, the system 10 includes a plurality of the decks 12 of playing cards, with each deck comprising a set of a defined number and type of card to play a given card game, or for use in some other manner. The decks 12 are offered to purchasers at various point of sale locations 22. These locations 22 may be any retail or business establishment that offers lottery games. In an alternative embodiment, the point of sale locations 22 may be any establishment where a consumer would expect to be able to purchase a deck of cards or other gaming paraphernalia. The point of sale locations 22 are desirably in communication with a central lottery authority 40 via any suitable communications network 42. A lottery authority 40 is responsible for control, management, inventory, monitoring, and all other control functions related to conduct of a wide area lottery game through multiple point of sale locations and, in this regard, known aspects and configurations of a wide area lottery network may be utilized to implement the system 10.

The lottery game play area 20 on one or a plurality of the cards 14 within the deck 12 can be formatted for play of various types of lottery games. For example, in the embodiment illustrated in FIGS. 2A and 2B, the first lottery game may be an instant scratch-off type of game, and the play area 20 may include one or more scratch-off areas 32 wherein a player determines if the card 14 has a winning lottery play by removing an opaque scratchable material from the areas 32 to reveal game indicia underneath. The revealed game indicia immediately identifies to the purchaser whether or not the card has a winning lottery play.

FIG. 4 illustrates an alternative embodiment wherein the lottery game component may be a Lotto-type of game. In this embodiment, the lottery play area 20 may include one or more randomly generated indicia, such as the set of numbers 34 illustrated in FIG. 4. These numbers 34 constitute the players selection or “hand” in a subsequent lottery drawing wherein numbers are randomly selected and published by the lottery authority 40. The card 14 is a winning lottery play if the indicia 34 in the play area 20 matches a designated combination of the numbers generated by the lottery authority 40, as in a conventional Lotto-type of game.

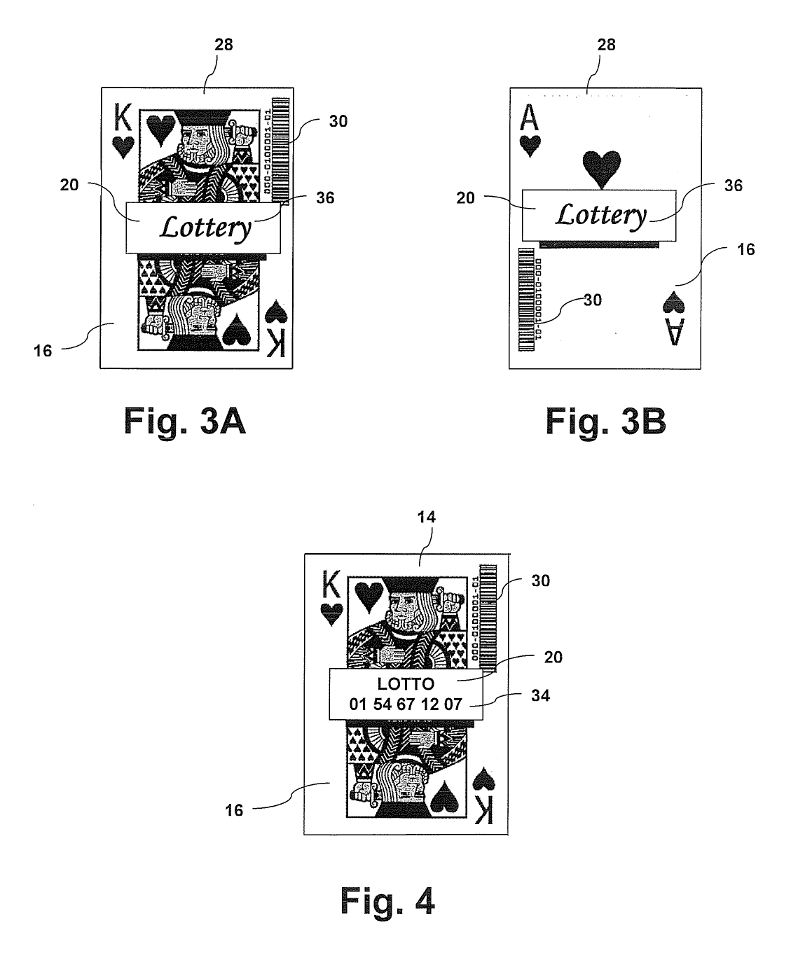

FIGS. 3A and 3B illustrate an alternative embodiment wherein the lottery game play area simply contains a designation 36 that the card is a lottery card. All of the designated cards within a deck 12 may, in turn, define the purchaser's hand or entry in a first lottery game. For example, the first lottery game may be a Lotto-type of game wherein the purchaser's entry in this game corresponds to the indicia on the lottery cards in the deck 12. For example, referring to FIGS. 3A and 3B, the player's hand may include a king or an ace, or a pair of hearts, and so forth. The deck 12 may contain any number of designated cards, for example five cards. The five cards would then be used as the player's entry in a subsequent lotto draw. For example, the lotto draw may be a randomly generated set of five suit symbols, such as a combination of hearts, clubs, spades, and diamonds. If the suits of the five cards in the player's hand matches the drawn cards, or some combination thereof, then the player may have a winning hand. Thus, in this scenario, the first lottery game is conducted with a subset of cards 14 within the deck 12 having a lottery play area 20 and, thus, no individual card is considered as a unique independent lottery ticket or card.

As mentioned above, it should be appreciated that the present game system and methodology are not limited by the particular type of lottery game implemented by the cards 14 in the deck 12. It is within the scope and spirit of the invention that the cards 14 may be utilized to conduct any suitable lottery game.

Referring to the cards 14, in the figures, each of the lottery cards 14 may include a bar code 30 that serves any number of functions. The bar code 30 may include any combination of inventory data, validation data, security data, and the like.

It should be understood that at least one of the cards 14 within a deck 12 includes the lottery game play area 20. In alternate embodiments, a plurality, but less than all, of the cards within the deck may include the lottery game play area 20. In still another embodiment, all of the cards within the deck 12 may include the lottery game play area 20. Regardless of the number of cards incorporating the game play area 20, the area 20 on the front or playing face 16 of the card does not obscure the essential indicia on the card, such as in the embodiments illustrated in FIGS. 2A, 2B, 3A, 3B, and 4. In this manner, even if the card is not a winner in the first lottery game component, the card 14 may remain in the deck 12, and the deck 12 can be used by a purchaser in any manner that a comparable deck unrelated to a lottery game would be used. For example, every card within a 52-card poker playing set deck 12 may be configured as the cards in FIGS. 2A and 2B such that the purchaser in essence also purchases 52 separate lottery tickets having a scratch-off lottery play component in the respective play areas 20. Even if every card 14 is a losing card, the deck 12 may still be used for playing any game that could otherwise be played by a conventional 52-card playing set.

Cards 14 within the deck 12 having a winning lottery play are redeemable for their prize award. In this regard, referring to FIG. 5, at least one redemption location 24 is provided wherein a purchaser may redeem winning cards 26. This redemption location 24 may be any one of the same retail establishments that sells the deck of cards, or a completely separate retail establishment, or a central lottery game office or establishment. The location and manner in which the winning lottery cards 14 are redeemed is not a limiting factor.

Generally, it is desirable for the central lottery authority 40 to keep the redeemed cards for any number of reasons. In this event, replacement cards 28 (FIG. 5) are provided to the purchaser when the winning cards 26 are redeemed. These replacement cards 28 are substituted for the redeemed cards in the deck 12 so that the purchaser still has a complete deck for playing a card game with the deck 12. The replacement cards 28 have the same back face 18 as every other card in the deck 12, and may or may not have an indication on the front or playing face 16 that the card is a substitute for a winning lottery card. For example, referring to the king of hearts card 14 illustrated in FIG. 4, upon redeeming this card, a purchaser may be presented with a substitute king of hearts card that is void of any indication on the face 16 that the card was involved in a lottery game play. In an alternate embodiment, the replacement card may simply incorporate an indication that the card is a replacement card for a winning lottery card. Such a card may have the same appearance as the cards illustrated in FIGS. 3A and 3B, as an example. This configuration may be desired in that the purchaser may, at some later time, review the deck 12 to determine how many cards within the deck were actually involved in the first lottery game component.

In a particularly unique embodiment, the present system and methodology may include an additional lottery game component independent from the first lottery game component wherein the cards 14 within the deck 12 having a winning lottery play in the first lottery game are used as player cards in the additional lottery game. For example, the deck 12 may be a 52-card poker playing deck with a plurality (or all) of the cards 14 having the lottery game play area 20. The additional lottery game may have a poker theme, and any of the cards having a winning lottery play in the first lottery game may be used as the player's hand in the additional lottery poker game. For example, if seven cards within the deck 12 were used in the first lottery game component, then the purchaser may use any combination of the seven cards to form the best possible five-card poker hand. The lottery authority 40 may have an established payout for various poker hands, and the player may use the winning cards to form the highest possible paying hand.

In still an alternative embodiment, all of the cards 14 within a deck 12 having a lottery play area (whether winning or losing) may be used in the subsequent additional lottery game. For example, in the poker-theme game discussed above for the additional lottery game, the player is not limited to cards 14 having a winning lottery play in the first game component, and may form the best possible poker hand with any of the cards 14 having a lottery game play area 20.

It is within the scope and spirit of the invention that any combination of the cards 14 within the original deck 12 having a lottery game play area 20 be used in any manner of subsequent additional lottery game.

As discussed, the present invention also includes various embodiments of the methodology for integrating a lottery game with a deck of playing cards, as related to the system and processes described above. In particular, the method includes making available to purchasers a deck of playing cards having a set of a defined number and type of cards to play any manner of card game. At least one of the cards within each deck is provided with a lottery game play area provides the purchaser with a chance to win a prize in the first lottery game. All of the cards within the deck are provided with the same visually appearing back face such that the cards are indistinguishable from the back face. Any card within the deck having a winning lottery game play in the first lottery game may be redeemed by the purchaser to the lottery authority, and the purchaser is provided with a replacement card that may be substituted for the redeemed card or cards so that the purchaser has a complete deck of cards for playing any manner of card game with the deck, as discussed above.

Various other embodiments and aspects of the inventive methodology are readily apparent from the above discussion.

It should be appreciated by those skilled in the art that various modifications and variations may be made to the card system, gaming system, and methodology of the present invention without departing from the scope and spirit of the invention. It is intended that the present invention include such modifications and variations as come within the scope of the appended claims.

What is claimed is:

1. A system for combining a lottery game with playing cards, comprising:
a plurality of decks of playing cards, each said deck comprising a set of a defined number and type of cards to play a given card game;
at least one of said cards within each said deck comprising a lottery game play area that provides a purchaser of said deck with a chance to win a prize in a first lottery game, all said cards within a deck having the same visually appearing back face such that said cards are indistinguishable from said back face;
at least one point of sale for said decks;
at least one redemption location wherein purchasers redeem cards from said decks having a winning lottery game play in said first lottery game; and
replacement cards at said redemption location that are substituted for said redeemed cards so that purchasers have a complete said deck for playing said card game after redeeming a card having a winning lottery game play.

2. The system as in claim 1, wherein said decks comprise a poker playing deck.

3. The system as in claim 1, wherein said decks comprise a pinochle playing deck.

4. The system as in claim 1, wherein said decks comprise any conventional deck of cards used to play a wagering card game or a board game.

5. The system as in claim 1, wherein a plurality of said cards within each said deck comprises said lottery game play area.

6. The system as in claim 1, wherein said lottery game play area comprises a scratch-off lottery game.

7. The system as in claim 1, wherein said lottery game play area comprises randomly generated indicia that a player attempts to match to indicia drawn in a subsequent lottery drawing by a central lottery authority.

8. The system as in claim 1, wherein said lottery game play area comprises an indication that said card is designated as a lottery game card, wherein said cards within said deck having said lottery game play area are used collectively in play said first lottery game.

9. The system as in claim 1, comprising an additional lottery game component wherein cards within said deck having a winning lottery play in said first lottery game are used as player cards in said additional lottery game.

10. The system as in claim 9, wherein said deck comprises a poker playing deck having a plurality of said cards with said lottery game play area, said additional lottery game having a poker theme, and wherein any of said cards having a winning lottery play in said first lottery game are used as the player's hand in said additional lottery game.

11. The system as in claim 1, comprising an additional lottery game component wherein cards within said deck having a lottery play in said first lottery game are used as player cards in said additional lottery game.

12. The system as in claim 11, wherein said deck comprises a poker playing deck having a plurality of said cards with said lottery game play area, said additional lottery game having a poker theme, and wherein any of said cards having a lottery play in said first lottery game are used as the player's hand in said additional lottery game.

13. A card system having an integrated lottery game component; comprising:
at least one deck of cards having a set of a defined number and type of cards for playing a specified card game;
at least one of said cards within said deck having a lottery game play area that provides a purchaser of said deck with a chance to win a prize in a first lottery game; and
all of said cards within a deck having the same visually appearing back face such that said cards are indistinguishable from said back face.

14. The card system as in claim 13, further comprising replacement cards that are substituted for cards having a winning lottery play so that the purchasers have a complete said deck for playing said card game after redeeming a card having a winning lottery game play.

15. The card system as in claim 13, wherein said deck comprises a poker playing deck.

16. The card system as in claim 13, wherein said deck comprises a pinochle playing deck.

17. The card system as in claim 13, wherein said deck comprises any deck of cards used to play a wagering card game or a board game.

18. The card system as in claim 13, wherein a plurality of said cards within said deck comprises said lottery game play area.

19. The card system as in claim 13, wherein said lottery game play area comprises a scratch-off lottery game.

20. The card system as in claim 13, wherein said lottery game play area comprises randomly generated indicia that a player attempts to match to indicia drawn in a subsequent lottery drawing by a central lottery authority.

21. The card system as in claim 13, wherein said lottery game play area comprises an indication that said card is designated as a lottery game card, wherein said cards within said deck having said lottery game play area are used collectively in play said first lottery game.

22. The card system as in claim 13, wherein cards within said deck having a winning lottery play in said first lottery game are used as player cards in an additional lottery game.

23. The card system as in claim 22, wherein said deck comprises a poker playing deck having a plurality of said cards with said lottery game play area, said additional lottery game having a poker theme, and wherein any of said cards having a winning lottery play in said first lottery game are used as the player's hand in said additional lottery game.

24. The card system as in claim 13, wherein cards within said deck having a lottery play in said first lottery game are used as player cards in an additional lottery game.

25. The card system as in claim 24, wherein said deck comprises a poker playing deck having a plurality of said cards with said lottery game play area, said additional lottery game having a poker theme, and wherein any of said cards having a lottery play in said first lottery game are used as the player's hand in said additional lottery game.

26. The card system as in claim 13, wherein said deck comprises a plurality of cards in a fan-folded stack, with said cards connected at their longitudinal edges at separation lines.

27. A method for integrating a lottery game with a deck of playing cards, comprising:
making available to purchasers a deck of playing cards having a set of a defined number and type of cards to play a given card game;
providing at least one of the cards within each deck with a lottery game play area that provides the purchaser with a chance to win a prize in a first lottery game, all of the cards within the deck having the same visually appearing back face such that the cards are indistinguishable from the back face;
redeeming the cards from the deck having a winning lottery game play in a the first lottery game; and
providing replacement cards that are substituted for the redeemed cards so that purchasers have a complete deck for playing the card game after redeeming a card having a winning lottery game play.

28. The method as in claim 27, wherein the decks comprise a poker playing deck.

29. The method as in claim 27, wherein the decks comprise a pinochle playing deck.

30. The method as in claim 27, wherein the decks comprise any deck of cards used to play a wagering card game or a board game.

31. The method as in claim 27, comprising providing a plurality of the cards within the deck with the lottery game play area.

32. The method as in claim 27, wherein the first lottery game is an instant scratch-off lottery game played in the lottery game play area.

33. The method as in claim 27, wherein the first lottery game is a Lotto-type game, and the lottery play area includes a set of randomly generated indicia that a player attempts to match to indicia drawn in a subsequent lottery drawing by a central lottery authority.

34. The method as in claim 27, comprising conducting an additional lottery game wherein cards within the deck having a winning lottery play in the first lottery game are used as player cards in the additional lottery game.

35. The method as in claim 33, wherein the deck comprises a poker playing deck having a plurality of cards with the lottery game play area, the additional lottery game having a poker theme, and wherein any of the cards having a winning lottery play in the first lottery game are used as the player's hand in the additional lottery game.

36. The method as in claim 26, comprising conducting an additional lottery game wherein cards within the deck having a lottery play in the first lottery game are used as player cards in the additional lottery game.

37. The method as in claim 35, wherein the deck comprises a poker playing deck having a plurality of cards with the lottery game play area, the additional lottery game having a poker theme, and wherein any of the cards having a lottery play in the first lottery game are used as the player's hand in the additional lottery game.
